(19) United States
(12) Patent Application Publication
(10) Pub. No.: US 2004/0166823 A1
(43) Pub. Date: Aug. 26, 2004

(54) Control interface scheme for wireless communication chipsets

(75) Inventor: Martin Alderton, San Diego, CA (US)

Correspondence Address: FITCH EVEN TABIN AND FLANNERY, 120 SOUTH LA SALLE STREET, SUITE 1600, CHICAGO, IL, 60603-3406, US

(73) Assignee: Magis Networks, Inc., San Diego, CA

(21) Appl. No.: 10/371,565

(22) Filed: Feb. 21, 2003

(51) Int. Cl. H04B 1/06; H04B 7/00

(52) U.S. Cl. 455/250.1; 455/251.1

(57) ABSTRACT

A control interface scheme provides for communicating control information between integrated circuits (ICs) in a wireless communication chipset. A serial 3-wire bus is configured to communicate a series of control words assembled on a digital IC to an analog IC prior to a data portion of a frame used by the wireless communication chipset in communicating data. The control words include control settings for use by the analog IC during the data portion of the frame. The control settings, which are stored in registers on the analog IC, include gain settings for two receivers and a transmitter, as well as phase lock loop (PLL) control information and power management information. Several timing signals generated on the digital IC are used by the analog IC during the data portion of the frame to select among the registers to obtain the appropriate control settings at the appropriate times. By sending all such control settings to the analog IC prior to the data portion of the frame, the PLLs on the analog IC are not disturbed.

### BACKGROUND OF THE INVENTION

1. Field of the Invention

The present invention relates generally to control interfaces in integrated circuits (ICs) used for implementing wireless communications, and more specifically to a control interface for communicating control information between ICs in a wireless communication chipset.

2. Discussion of the Related Art

For wireless communications, such as is used in a wireless local area network (WLAN), it is difficult to achieve a single IC (or “single chip”) solution that incorporates all radio frequency (RF), intermediate frequency (IF) and baseband (BB) circuitry. This difficulty is due to the noise, power consumption and process issues that arise when a single IC incorporates all RF, IF, mixed signal and digital circuits. For example, the baseband digital circuitry can cause phase and frequency transients in the phase lock loops (PLLs) in the RF and/or IF analog circuitry. As a result, the analog functions (RF and IF) are typically separated from some or all of the digital functions by using two or more separate ICs.

Even when separate ICs are used similar difficulties with respect to noise, power consumption and process issues can arise when communicating information between the ICs. Thus, the sensitivity of the components on the analog IC must be taken into account when communicating information thereto or else the transmitter and/or receiver performance may be degraded.

It is with respect to these and other background information factors that the present invention has evolved.

### SUMMARY OF THE INVENTION

The present invention advantageously addresses the needs above as well as other needs by providing a method of handling control information in a first integrated circuit (IC) used for wireless communications. The method comprises the steps of: receiving in the first IC a plurality of control settings that were generated in a second IC and communicated across a bus from the second IC to the first IC prior to a data portion of a frame used by the first and second ICs in communicating data; and receiving in the first IC one or more timing signals that are generated in the second IC and that are for use during the data portion of the frame for selecting certain ones of a plurality of registers in the first IC that are used for storing the plurality of control settings.

Another embodiment of the present invention provides a method of handling control information in a first integrated circuit (IC) used for wireless communications. The method comprises the steps of: receiving in the first IC a first control word and a second control word that were assembled in a second IC and communicated across a bus from the second IC to the first IC prior to a data portion of a frame used by the first and second ICs in communicating data, wherein the first control word includes a plurality of first receive gain settings for a first receiver amplifier, and the second control word includes a plurality of transmit gain settings for a transmitter amplifier; and receiving in the first IC one or more timing signals that are generated in the second IC and that are used during the data portion of the frame for selecting certain ones of a plurality of registers in the first IC that are used for storing the plurality of first receive gain settings and the plurality of transmit gain settings.

Another embodiment of the present invention provides a first integrated circuit (IC) for use in wireless communications. The first IC comprises a serial interface that is configured to receive a plurality of control settings communicated from a second IC prior to a data portion of a frame used by the first and second ICs in wirelessly communicating data. The plurality of control settings are for use by the first IC during the data portion of the frame. One or more inputs are configured to receive one or more timing signals from the second IC that are for use by the first IC during the data portion of the frame for selecting certain ones of a plurality of registers in the first IC that are used for storing the plurality of control settings.

A better understanding of the features and advantages of the present invention will be obtained by reference to the following detailed description of the invention and accompanying drawings which set forth an illustrative embodiment in which the principles of the invention are utilized.

### BRIEF DESCRIPTION OF THE DRAWINGS

The above and other aspects, features and advantages of the present invention will be more apparent from the following more particular description thereof, presented in conjunction with the following drawings wherein:

FIGS. 1A and 1B are block diagrams illustrating wireless communications chipsets having control interfaces that operate in accordance with embodiments of the present invention;

FIG. 2 is a block diagram illustrating a communications system that uses a chipset having a control interface that operate in accordance with an embodiment of the present invention;

FIGS. 3A, 3B and 3C are schematic diagrams illustrating a portion of a wireless communications chipset having a control interface that operates in accordance with embodiments of the present invention;

FIGS. 4A, 4B and 4C are timing diagrams illustrating the operation of a control interface made in accordance with embodiments of the present invention;

FIG. 5 is a flow diagram illustrating the operation of a control interface made in accordance with an embodiment of the present invention;

FIG. 6 is a table illustrating an example bit stream assignment for the RX1, RX2, TX1 and PLL control words that may be used with embodiments of the present invention;

FIG. 7 is a table that provides a description of the bits in the RX1 and RX2 control words in the example bit stream assignment shown in FIG. 6;

FIG. 8 is a table illustrating an example allocation of the bits in one of RX AGC registers;

FIG. 9 is a schematic diagram illustrating an example configuration for the RX1, RX2 register banks and demultiplexers shown in FIGS. 3B and 3C;

FIG. 10 is a table that provides a description of the bits in the TX1 control word in the example bit stream assignment shown in FIG. 6;

FIG. 11 is a table illustrating an example relationship between the AT[2:0] bit pattern and attenuation for a 60 MHz TX attenuator;

FIG. 12 is a table illustrating an example allocation of the bits in one of TX1 VGA registers;

FIG. 13 is a schematic diagram illustrating an example configuration for the TX1 register banks and demultiplexers shown in FIGS. 3B and 3C;

FIGS. 14A, 14B and 14C are tables illustrating an example an example bit mapping of the RF PLL control word shown in the example bit stream assignment shown in FIG. 6;

FIG. 15 is a table illustrating an example configuration for the two enable bits EN[1:0] in the PLL control word for the power management mode selection block;

FIG. 16 is a table illustrating an example timing requirement for the serial 3-wire bus;

FIG. 17 is an example timing diagram for the serial 3-wire bus;

FIG. 18 is an example timing diagram for the RX1, RX2 control;

FIG. 19 is an example timing diagram for the TX1 control;

FIG. 20 is an example timing diagram for the RX received signal strength indicator (RSSI) sampling scheme that may be used with embodiments of the present invention.

Corresponding reference characters indicate corresponding components throughout the several views of the drawings.

### DETAILED DESCRIPTION

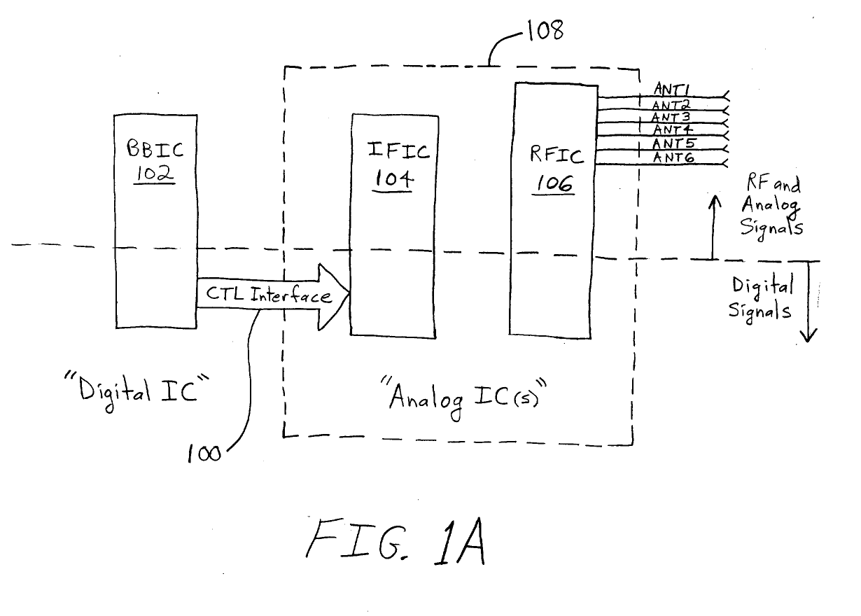

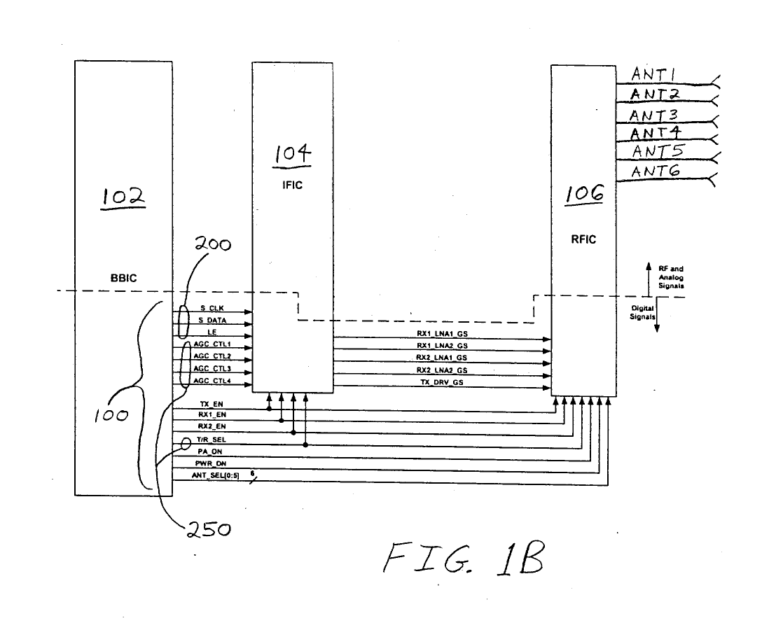

Referring to FIG. 1A, there is illustrated a control interface 100 that operates in accordance with an embodiment of the present invention. The control interface 100 may be used for communicating control information between integrated circuits (ICs) in a wireless communication chipset. The control interface 100 significantly diminishes the adverse effects caused by the noise, power consumption and process issues discussed above.

The control interface 100 is particularly suited for use in wireless communications chipsets that have the analog radio frequency (RF) and intermediate frequency (IF) functions separated from some or all of the digital functions by using two or more separate ICs. For example, the control interface 100 may be used for communicating control information from a baseband (BB) IC 102 to a separate IFIC 104 where the RFIC 106 is also a separate chip. Alternatively, the control interface 100 may be used for communicating control information from the BBIC 102 to a single IC 108 that includes both the IF circuitry and the RF circuitry. Thus, the control interface 100 may be used with wireless communication chipsets that comprise a total of two ICs (where the analog IF circuitry and the analog RF circuitry are included on the same IC) or wireless communication chipsets that comprise a total of three ICs (where the analog IF circuitry and the analog RF circuitry are each placed on their own ICs).

The BBIC 102 will be referred to herein as the “digital IC,” and the IFIC 104 and the RFIC 106, whether separate or combined, will be referred to herein as the “analog IC(s).” It should be noted that the analog IC(s) may also include some digital circuitry, and the digital IC may also include some analog circuitry. FIG. 1B will be referred to below with respect to an example set of implementation details for an embodiment of the present invention.

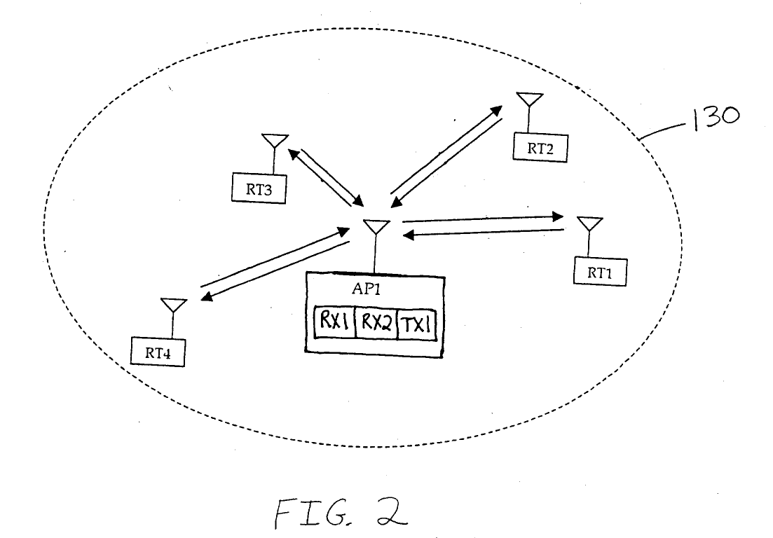

Referring to FIG. 2, in order to provide an example context in which the control interface 100 may be used, a brief description of a wireless communication system 130 will first be provided. By way of example, the wireless communication system 130 may be the same or similar to those described in copending U.S. patent application Ser. No. 10/000,230, filed Nov. 30, 2001, entitled “METHOD AND APPARATUS FOR ADAPTIVE QoS-BASED JOINT RATE & POWER CONTROL ALGORITHM IN MULTI-RATE WIRELESS SYSTEMS”, and U.S. patent application Ser. No. 10/014,312, filed Dec. 11, 2001, entitled “METHOD AND APPARATUS FOR OPTIMAL RATE (PHY MODE) CONTROL IN WIRELESS MODEMS WITH VARIABLE BIT RATE (VBR) CAPABILITY”, the entire disclosures of both of which are hereby fully incorporated into the present application by reference.

In the wireless communication system 130, an access point AP1 must be able to communicate effectively with a number of distant remote terminals RT1, RT2, RT3, RT4 located at different distances from AP1. As illustrated, AP1 includes a transmitter TX1 and may include two separate receivers RX1 and RX2 for performing diversity reception. By way of example, such diversity reception may operate the same or similar to the type described in copending U.S. patent application Ser. No. 09/994,519, filed Nov. 26, 2001, entitled “METHOD FOR ESTIMATING CARRIER-TO-NOISE-PLUS-INTERFERENCE RATIO (CNIR) FOR OFDM WAVEFORMS AND THE USE THEREOF FOR DIVERSITY ANTENNA BRANCH SELECTION”, the entire disclosure of which is hereby fully incorporated into the present application by reference.

The transmitter TX1 and receivers RX1, RX2 are preferably implemented in a wireless communications chipset of one of the types described above that uses the control interface 100. Each of the RTs may be configured identical to AP1. It should be understood that the present invention is not limited to use in systems that use diversity reception or that include two receivers. The present invention may be used in systems having any number of receivers.

Because the RTs are typically not co-located, the propagation path loss from each of the RTs to AP1, as well as the propagation path loss from AP1 to each of the RTs, may be quite different due to range and obstruction differences. Therefore, the level of received signal seen by the receivers RX1, RX2 in AP1 from each of the RTs may be quite different. Similarly, the level of transmitted signal sent by the transmitter TX1 in AP1 to each of the RTs may be quite different.

The communication by AP1 with the multiple RTs is preferably accomplished within any single PHY-layer frame, which is also known as a medium access control (MAC) frame, or simply “a frame.” By way of example, the frame may be 1 msec in length, but it should be understood that the frame may be any length appropriate for the system. Each frame includes a preamble portion and a data portion. The preamble portion is typically used for signal detection, frequency offset estimation, timing synchronization and channel estimation. The data portion, of course, carries the data. Each RT is preferably allocated a well defined “timeslot” within the data portion of the frame.

A post-amble of the frame may be used for diversity antenna branch selection, as described in the aforementioned U.S. patent application Ser. No. 09/994,519. Specifically, the chipset may be configured to select from among several antennas, such as six antennas as shown in FIG. 1A, in order to find the two best antennas for use with the receivers RX1, RX2.

The wireless communication system 130 preferably utilizes Orthogonal Frequency Division Multiplexing (OFDM) of a number of 64 QAM data streams. Such a modulation and multiplexing scheme is extremely sensitive to distortion and noise, as well as interference. In order to avoid such distortion a high degree of linearity is preferably employed in both the radio receivers RX1, RX2 and the radio transmitter TX1 at all times.

In order to achieve such a high degree of linearity, the gain of each of the receivers RX1, RX2 are periodically “tailored” to the received signal level to ensure that the received signal remains small enough such that distortion is minimized, yet large enough such that ambient noise does not swamp out the desired signal. This periodic gain tailoring is referred to as adaptive gain control or, more commonly, “automatic gain control” (AGC). The periodicity of the AGC update is preferably selected such that typical fluctuations in received signal level (due to propagation conditions such as multipath) can be compensated so that distortion and noise are minimized.

In addition, it is advantageous from an interference point of view to try to minimize transmitter TX1's transmit power so that any receiver, in communication with a transmitter, receives a signal that is the lowest possible power that is still consistent with meeting the performance requirements of the system. This can be achieved by periodically tailoring transmitter TX1's output power to ensure that adequate signal to noise ratio is maintained while transmitter output power is minimized. This periodic power tailoring is referred to as “power level control” (PLC). The periodicity of the PLC update is preferably selected such that typical fluctuations in path loss (due to propagation conditions such as multipath) can be compensated so that transmit power is minimized while performance objectives are met.

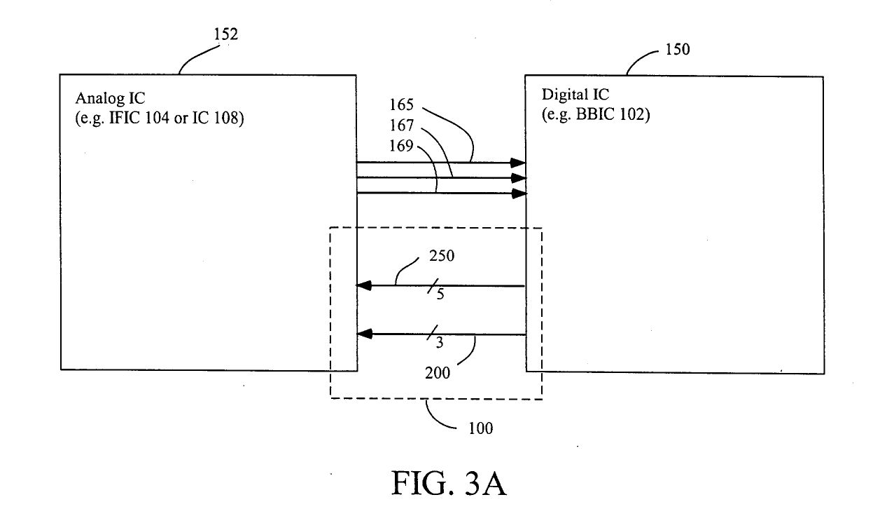

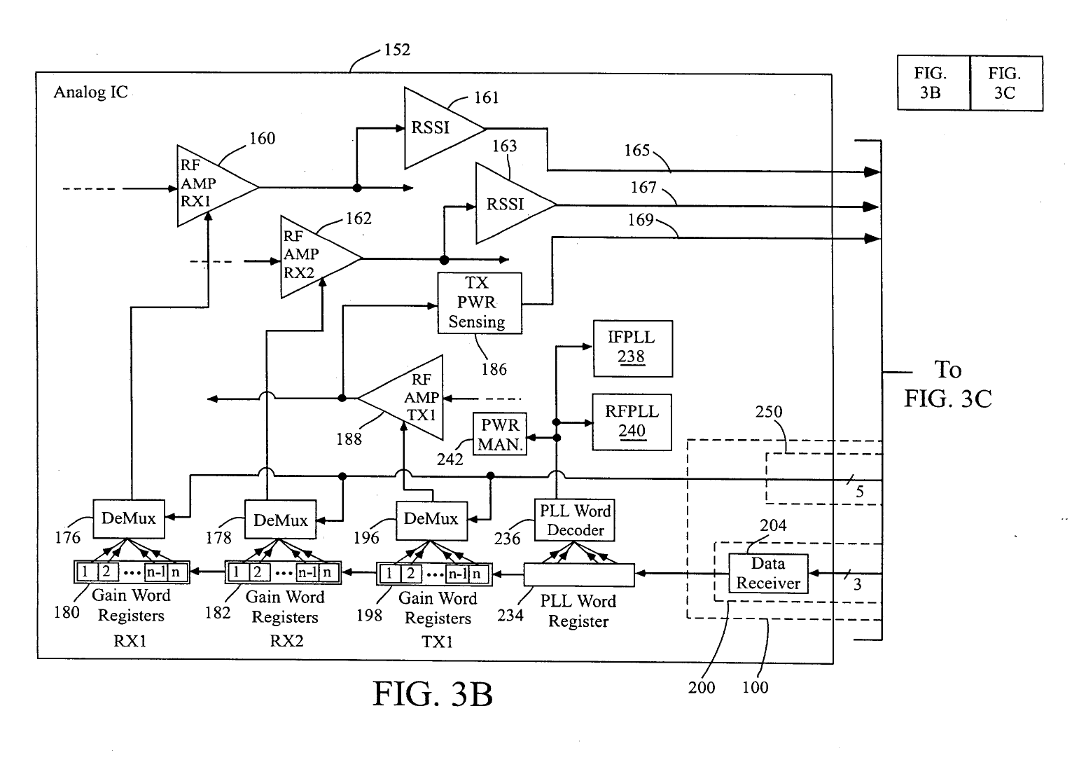

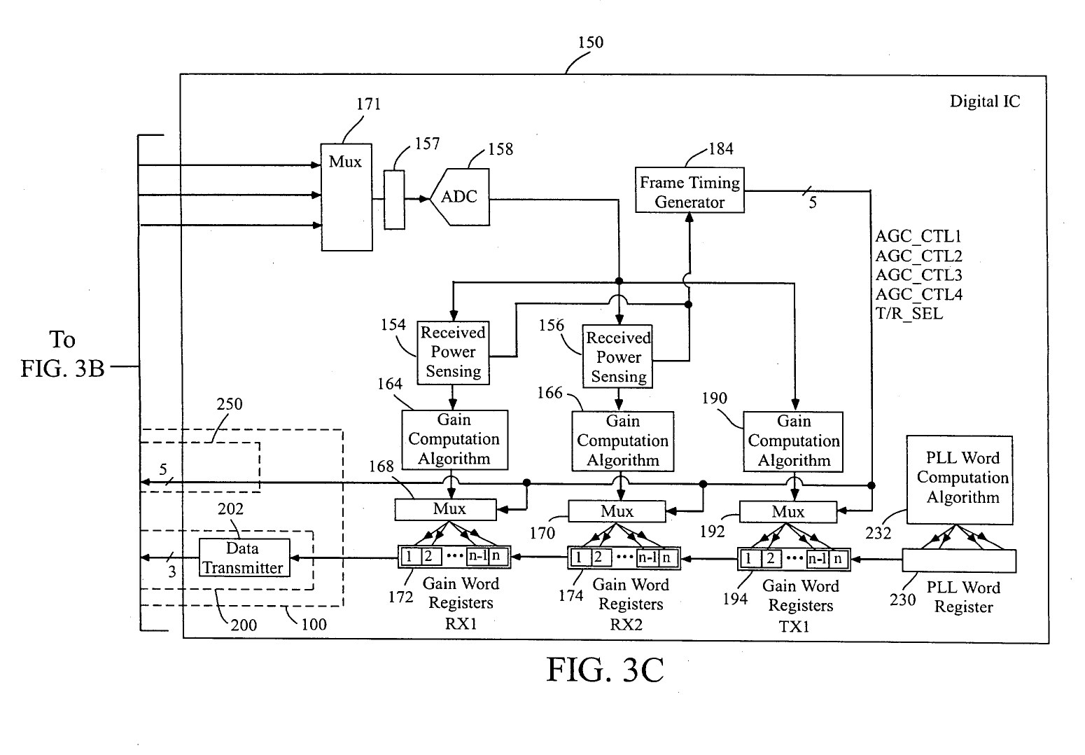

Referring to FIGS. 3A, 3B and 3C, there is illustrated a portion of the wireless communications chipset on which the transmitter TX1 and receivers RX1, RX2 are implemented. As illustrated, some portions of the circuitry are located on a digital IC 150, which for example may comprise the BBIC 102 (FIG. 1A). Other portions of the circuitry are located on an analog IC 152, which for example may comprise the IFIC 104 or the single IC 108 that includes both the IF and RF circuitry. The control interface 100 is used for communicating control information from the digital IC 150 to the analog IC 152.

The illustrated portions of the digital IC 150 and the analog IC 152 illustrate one possible implementation of the AGC “engines” that provide the AGC updates for receivers RX1, RX2. Initially, it is noted that the two diversity receivers RX1, RX2 each receive their own separate AGC updates. This is because the received signal level for RX1 may be quite different than the received signal level for RX2. As such, RX1 and RX2 need to each be periodically tailored to their own received signal level.

Each AGC engine may generally comprise a control loop, which includes a received power sensing system coupled to a gain steering system. Since the OFDM waveform exhibits very high peak-to-average ratio (PAR), it is generally advantageous to perform power sensing and averaging in the digital domain. Thus, two received power sensing blocks 154, 156 for RX1 and RX2, respectively, follow the analog-to-digital converter (ADC) 158 on the digital IC 150. It is also advantageous to utilize a digital AGC, which means that the gain steering systems' outputs to the receiver RF amplifiers 160, 162 for RX1 and RX2, respectively, are in the form of digital words that are used to set gains in the receivers in discrete steps. This simplifies the interface between the AGC and the receivers, as well as the gain blocks in the receivers. Two gain computation algorithm blocks 164, 166 for RX1 and RX2, respectively, in the digital IC 150 generate the digital AGC words.

Since the received signal power coming from each of the RTs can be vastly different and uncorrelated from the point of view of AP1, a separate AGC engine is used by each receiver RX1, RX2 for each RT-AP communication link, with the appropriate AGC engine acting only during the timeslot of its associated RT-AP link. This separate AGC engine could be accomplished by using a separate receive chain for each timeslot, but this would require inordinate hardware complexity. Alternatively, a single receive chain could be used with the AGC being reprogrammed at the beginning of each timeslot, but the clocking of data to the receiver has the potential to disrupt sensitive frequency sources (e.g., phase lock loops) within the receiver, which causes unacceptable degradation in performance. Furthermore, this approach is undesirable because the scheduling of this data transfer can be difficult. Therefore, the separate AGC engine is preferably accomplished by programming all AGC settings at the beginning of the frame, then using control timing signal(s) to apply the setting for each timeslot at the appropriate time.

The illustrated AGC engines include a distinct gain word register for every timeslot. Specifically, two gain word register banks 172, 174 located on the digital IC 150 for RX1, RX2, respectively, each include a register for each timeslot. In this example, each register bank includes four gain word registers to correspond to the four timeslots needed to communicate with the four RTs. Thus, in accordance with certain embodiments of the present invention the number of RTs will determine the number of timeslots, which determines the number of gain word registers in the register banks 172, 174. It should be well understood that the present invention is not limited to the use of four timeslots and associated gain word registers and that any number of timeslots and registers may be used. Furthermore, the two diversity receivers RX1, RX2 each have their own register banks 172, 174, respectively, for holding separate gain word registers because, as mentioned above, each of the receivers RX1, RX2 receives its own separate AGC updates.

Two multiplexers 168, 170 load the AGC words from the gain computation algorithm blocks 164, 166 into the appropriate one of the gain word registers in the register banks 172, 174 located on the digital IC 150. Two demultiplexers 176, 178 on the analog IC 152 select the appropriate AGC words during each timeslot from the gain word registers in the register banks 180, 182. The multiplexers 168, 170 and demultiplexers 176, 178 are controlled by timing signals generated by a frame timing generator 184 on the digital IC 150. These timing signals determine the correct time at which each of the AGC words should be applied to the receiver RF amplifiers 160, 162.

The illustrated portions of the digital IC 150 and the analog IC 152 also illustrate one possible implementation of a PLC engine that provides the PLC updates for transmitter TX1. The PLC engine may generally comprise a control loop which includes a transmit power sensing system coupled to a gain steering system. Assuming that the wireless communication system 130 is a TDD (time-division duplex) system and the OFDM waveform exhibits very high peak-to-average ratio (PAR), it is generally advantageous to perform analog power sensing and perform averaging in the digital domain. Thus, an analog transmitter power sensing block 186 is located on the analog IC 152 for sensing the output power of the transmitter RF amplifier 188. It is also advantageous to utilize a digital PLC, which means that the gain steering system's output to the transmitter RF amplifier 188 is in the form of a digital word which is used to set gains in the transmitter in discrete steps. A gain computation algorithm block 190 on the digital IC 150 following the analog-to-digital converter (ADC) 158 generates the digital PLC words.

Since the path loss to each of the RTs can be vastly different and uncorrelated from the point of view of AP1, a separate PLC engine is used for each AP-RT communication link, with the appropriate PLC engine acting only during the timeslot of its associated AP-RT link. Similar to the separate AGC engines, the separate PLC engine is preferably accomplished by programming all PLC settings at the beginning of the frame, then using control timing signal(s) to apply the setting for each timeslot at the appropriate time.

Similar to the AGC engines, the illustrated PLC engine includes a distinct gain word register for every timeslot. Again, the number of RTs determines the number of timeslots, which determines the number of gain word registers. A multiplexer 192 loads the PLC words from the gain computation algorithm block 190 into the appropriate one of the gain word registers in the register bank 194 located on the digital IC 150. A demultiplexer 196 selects the appropriate PLC word during each timeslot from the gain word registers in the register bank 198 located on the analog IC 152 and applies the PLC word to the transmitter RF amplifier 188. The multiplexer 192 and demultiplexer 196 are controlled by timing signals generated by the frame timing generator 184. These timing signals determine the correct time at which each of the PLC words should be applied to the transmitter RF amplifier 188.

The control interface 100 is used for communicating the AGC words, the PLC words and the timing signals from the digital IC 150 to the analog IC 152. In the illustrated embodiment, the control interface 100 comprises a serial bus 200 for communicating the AGC words and the PLC words. The serial bus 200 preferably comprises a serial three-wire bus, or alternatively an I²C interface, which minimizes the pin count of both ICs. The serial bus 200 typically comprises a data transceiver having a data transmitter 202 and a data receiver 204 that pass the contents of the gain word register banks 172, 174, 194 on the digital IC 150 to the gain word register banks 180, 182, 198 on the analog IC 152, respectively.

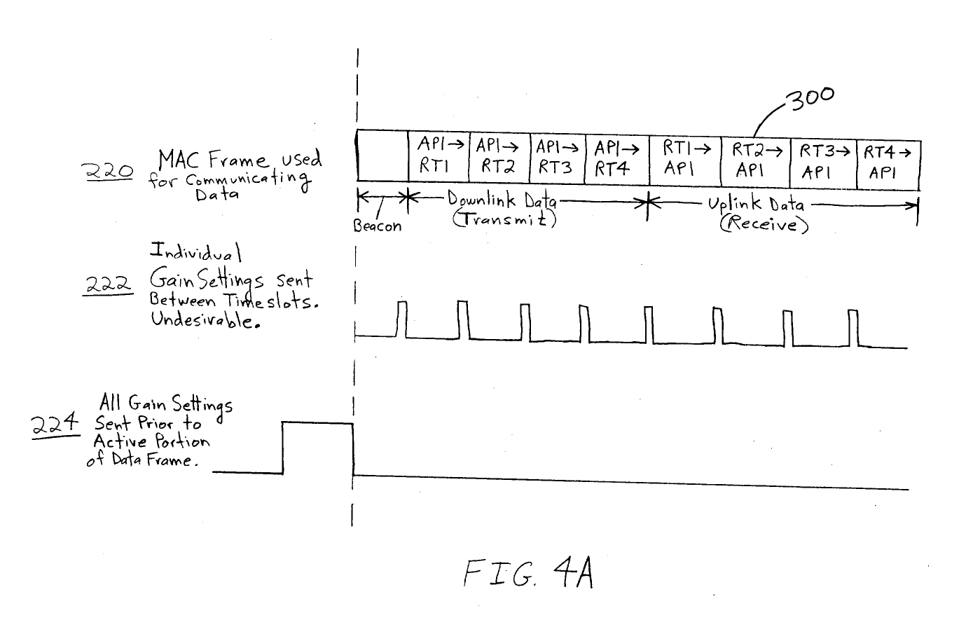

Referring to FIG. 4A, there is illustrated a frame (or MAC frame) 220 used by the wireless communications chipset in communicating data between AP1 and RT1, RT2, RT3, RT4. During the transmit (or downlink) portion, there is a separate timeslot for AP1 to transmit data to each of the RTs. During the receive (or uplink) portion, there is a separate timeslot for AP1 to receive data from each of the RTs.

FIG. 4B illustrates one example communications burst structure that may be used for each of the timeslots in the receive (or uplink) portion. Illustrated is the burst structure 300 for the timeslot where AP1 receives data from RT2. The burst 300 includes a preamble portion 302, a data portion 304, and a diversity selection portion 306 (or “post-amble”) designed for use with six antenna branches. Specifically, five repeated channel probing OFDM long symbols 308, 310, 312, 314, 316 are included in the diversity selection portion 306, which supports three probing portions 318, 320, 322 and four switching time intervals 324, 326, 328, 330, such that six-branch receive diversity is supported with the two RF receivers RX1, RX2. Thus, in order to probe the available diversity branches, antenna branches ANT1, ANT2 (FIG. 1A) are switched on (i.e., coupled to their respective receivers) during switching time interval 324 and then measured during probing portion 318, antenna branches ANT3, ANT4 are switched on during switching time interval 326 and then measured during probing portion 320, and antenna branches ANT5, ANT6 are switched on during switching time interval 328 and then measured during probing portion 322.

It should be well understood that the burst 300 is just one example burst that may be used in the MAC frame 220. As described in the aforementioned U.S. patent application Ser. No. 09/994,519, the diversity selection portions of the various bursts of the MAC frame may be located in different locations within each burst, e.g., within the preamble portion, between the preamble portion and the data portion, within the data portion, or as a post-amble.

Waveform 222 (FIG. 4A) illustrates a scenario where the individual gain settings (i.e. the individual AGC and PLC words) are sent over the serial bus 200 of the control interface 100 at the boundary between timeslots of the frame 220. It has been found herein that this is undesirable due to the chipset's susceptibility to performance degradation when noise is coupled into the analog IC 152. Namely, such high frequency clocking of data onto the analog IC 152 tends to cause phase and frequency transients in the phase lock loops (PLLs) on that IC, and until these transients have settled out, receiver performance may be degraded. In addition, the scheduling of transfer of data from the digital IC 150 to the analog IC 152 at the boundary between timeslots results in added complexity on the part of the scheduling software and circuitry.

Waveform 224 illustrates the manner in which the gain settings are sent over the serial bus 200 of the control interface 100 in accordance with an embodiment of the present invention. Namely, the serial bus 200 of the control interface 100 clocks all of the gain settings (i.e., all of the AGC and PLC words) from the digital IC 150 to the analog IC 152 prior to the data portion of the frame 220 used by the wireless communications chipset in communicating data. This ensures that all of the serial bus 200 activity occurs before the beginning of the active data portion of the frame 220, which improves the performance of the system by reducing the likelihood of PLLs on the analog IC 152 being subjected to phase and frequency disturbances during the active data portion of the frame. Also, by grouping all serial bus 200 activity together at the beginning of the frame 220, the scheduling of transfer of data from the digital IC 150 to the analog IC 152 is simplified.

It is preferable to burst the control settings information out in short time bursts in order to minimize the amount of potential interference to transmit and receive time-slot operations and minimize the amount of time a control processor must spend communicating over the control interface.

Once all of the gain settings have been sent from the digital IC 150 to the analog IC 152, then during the active data portion of the frame 220 the demultiplexers 176, 178 select the appropriate AGC words from the gain word register banks 180, 182 during each timeslot in response to word selection timing signals provided by the frame timing generator 184. Again, each of the diversity receivers RX1, RX2 has its own gain word register bank 180, 182, respectively, because each receiver RX1, RX2 receives it own separate AGC update for each timeslot. The demultiplexer 196 similarly selects the appropriate PLC word from the gain word register bank 198 during each timeslot in response to word selection timing signals provided by the frame timing generator 184.

In accordance with another embodiment of the present invention, phase lock loop (PLL) control information is also communicated across the serial bus 200 from the digital IC 150 to the analog IC 152 prior to the data portion of the frame 220 used by the wireless communications chipset in communicating data. The PLL control information is generated on the digital IC 150 by the PLL word computation algorithm 232 and loaded into the PLL word register 230. By way of example, the PLL control information may include information for controlling an IF PLL 238, an RF PLL 240, and a power management mode selection block 242.

The PLL control information is communicated across the serial bus 200 in a control word that is separate from the control words carrying the gain settings. By grouping the gain control words (AGC and PLC) and the PLL functions into separate control words, the PLLs on the analog IC 152 are not disturbed with every gain control word update. Thus, grouping receive, transmit, and PLL control fields into separate words minimizes the amount of contamination and perturbation to sensitive circuits.

On the analog IC 152, the PLL control information is stored in the PLL word register 234. A PLL word decoder 236 selects the appropriate control information from the register 234 for control of the IF PLL 238, the RF PLL 240, and the power management mode selection block 242. The power management mode selection block 242 allows certain parts of the chipset to be turned off to save power. For example, it allows the serial bus 200 to be kept turned on while other parts of the chipset are powered down. Thus, power management mode information may be included with the PLL control information that is communicated across the serial bus 200 from the digital IC 150 to the analog IC 152.

In accordance with an embodiment of the present invention, the control interface 100 further comprises a timing signal bus 250. The timing signal bus 250 carries the word selection timing signals that are used by the multiplexers and demultiplexers to select the appropriate words at the appropriate times from the registers. In the illustrated embodiment, the timing signal bus 250 includes five signals that are generated by the frame timing generator 184 in the digital IC 150. The five timing signals include: AGC_CTL1, AGC_CTL2, AGC_CTL3, AGC_CTL4, and T/R_SEL. Therefore, the timing signals are communicated from the digital IC 150 to the analog IC 152 in the timing signal bus 250 and are used for selecting certain ones of the registers in the analog IC 152 that are used for storing the gain settings.

The above-discussion states that the control settings are sent from the digital IC 150 to the analog IC 152 prior to the data portion of the frame 220. It should be understood that the language “prior to the data portion of the frame” is intended to include the scenario where control settings are sent after a previous MAC frame and prior to the data portion of the next MAC frame, i.e., between MAC frames.

Waveform 225 in FIG. 4C illustrates the manner in which the control settings may be sent over the serial bus 200 of the control interface 100 in accordance with another embodiment of the present invention. In this embodiment some or all of the control setting information may be sent over the serial bus 200 during a subsequent non-active time slot within the same MAC frame. For example, if remote terminal RT3 is not active and is therefore not transmitting or receiving data, then additional control settings may be sent over the serial bus 200 during the transmit and/or receive timeslots for RT3 as shown. As another example, if RT3 is only actively receiving data, then additional control settings may be sent during the uplink timeslot for RT3, or if RT3 is only actively transmitting data, then additional control settings may be sent during the downlink timeslot for RT3. Timeslots for other inactive remote terminals may be similarly used.

Waveform 225 is useful for the scenario where the maximum number of RX control settings and TX control settings for a MAC frame have already been stored in the registers on the analog IC 152. If more control settings are needed during the same MAC frame, then additional control settings could be bursted over the interface to the analog IC 152 during one or more subsequent non-active time slot(s) within the same MAC frame as shown in waveform 225.

Other embodiments of the present invention seek to load most or all of the control information into the analog IC 152 via the serial bus 200 during time intervals where there is no transmit and no receive activity during a specific MAC frame. The serial control words may be sent out in a manner such that the only time-criticality is that they avoid sensitive transmit and receive time regions. Precision strobes and gating signals may be used to determine when each register value is used. This will achieve the objective of minimizing bus activity during sensitive TX and RX timeslots, alleviate the control processor from having to perform highly precise real-time processing, and permit precision high-speed switching (like between antenna pairs with diversity, or post-amble power measurements) with a minimum of overhead.

Still other embodiments of the present invention may permit some serial bus 200 activity during a portion of the transmit (downlink) time slots if necessary. It is preferable, however, to avoid any serial bus activity during sensitive receive time slots.

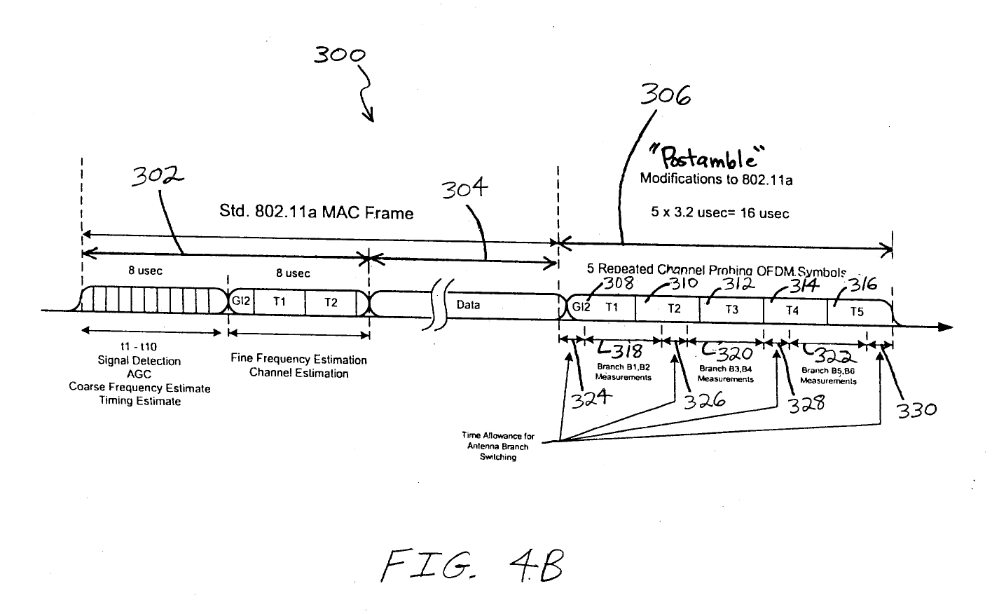

Referring to FIG. 5, there is illustrated a process flow 260 for the above-described hardware. Within the illustrated process flow is a method of operating the control interface 100 in accordance with an embodiment of the present invention. Specifically, in step 262 all of the control settings, which may include all of the AGC and PLC gain settings and the PLL control information, are generated for one frame on the digital IC 150. Typically, there will be a separate AGC and PLC gain setting for each timeslot, and there will be a separate timeslot for each RT. Furthermore, if more than one receiver RX is used, such as for diversity reception, each receiver will have its own set of AGC gain settings. It should be understood that the control settings may include additional information other than the AGC and PLC gain settings and the PLL control information.

All of the control settings for the one frame are loaded into shift registers 172, 174, 194, 230 on the digital IC 150 in step 264. In step 266 some or all of the control settings for the one frame are communicated across the serial bus 200 to the analog IC 152 prior to the data portion of the frame 220 used by the wireless communications chipset in communicating data. In other words, some or all of the control settings for the one frame are “preloaded” onto the analog IC 152 prior to the data portion of the frame 220. If needed, additional control settings may be communicated across the serial bus 200 during one or more inactive time slots within the same frame 220. It should be understood that control settings for more than one frame may be preloaded onto the analog IC 152 in accordance with other embodiments of the present invention.

In step 268 some or all of the control settings for the one frame are stored in registers 180, 182, 198, 234 on the analog IC 152. In step 270 timing signals generated on the digital IC 150 are communicated to the analog IC 152. And in step 272, during the data portion of the frame 220, the timing signals are used to select certain registers on the analog IC 152 to obtain the appropriate control settings at the appropriate times.

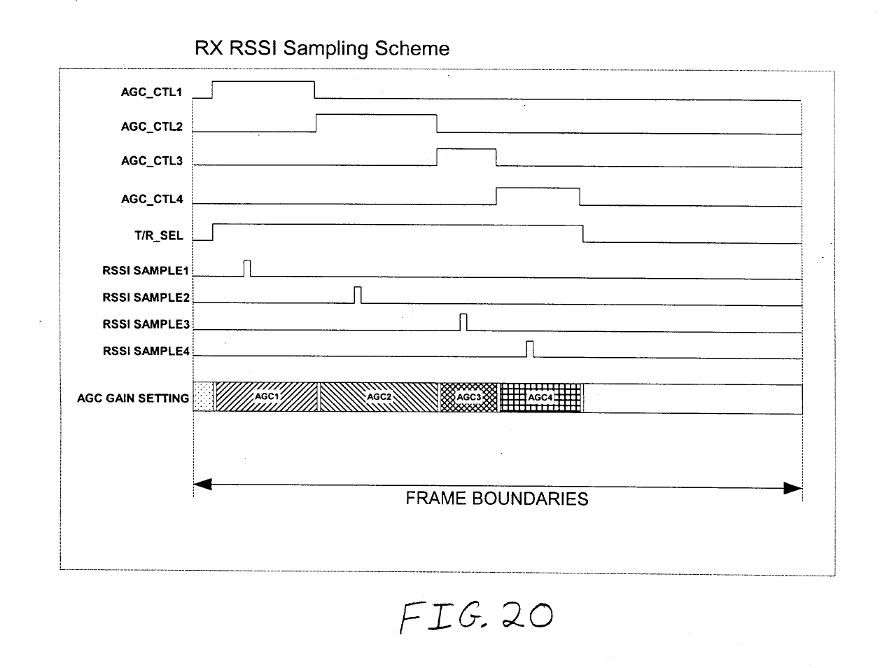

During the data portion of the frame 220 when certain registers on the analog IC 152 are being selected to obtain the appropriate gain settings, power measurements are also being taken to determine the gain settings for the next frame. The gain settings, and other control settings, for the next frame are generated and stored in the register banks on the digital IC 150. Thus, steps 262 and 264 of the process flow 260 may actually take place during step 272 of the previous frame. An example of a scheme for generating RX AGC gain settings is provided in FIG. 20 and the accompanying discussion.

Use of the control interface 100 and the method of communicating control information described herein has several advantages. One advantage is the speed at which the gain settings are made available to the amplifiers. Namely, by communicating all of the gain settings (i.e., all of the AGC and PLC words) to the analog IC 152 prior to the data portion of the frame 220, all of the gain settings are readily available on the analog IC 152 where the amplifiers are located. This allows each of the gain settings to be rapidly read out of the registers in a timely manner without disturbing the PLLs on the analog IC 152. This rapid switching between gain settings substantially improves system performance. Therefore, the timing and speed at which the present invention allows the control information to be made available to the amplifiers helps to avoid disturbance of the PLLs.

In addition, the rapid switching between gain settings in the receivers RX1, RX2 allows for fast switching between multiple antennas for purposes of the diversity antenna branch selection mentioned above and described in the aforementioned U.S. patent application Ser. No. 09/994,519. Specifically, the ability to rapidly switch between gain settings allows the system to rapidly take measurements from each antenna and then quickly switch to the next antenna during the process of finding the two best antennas for use with the receivers RX1, RX2. It is highly advantageous to be able to perform this fast antenna switching because this decreases the amount of time in which the best antennas can be found and selected.

The following description will provide an example set of implementation details for an embodiment of the present invention. Several of the control signals mentioned below are illustrated in FIG. 1B. It should be understood that this is just one example set of implementation details and that many variations may be used in accordance with the present invention. In this example it will be assumed that the serial bus 200 comprises a 3-wire bus with the 3 wires comprising: serial bus clock S_CLK, serial bus data S_DATA, and serial bus latch enable LE.

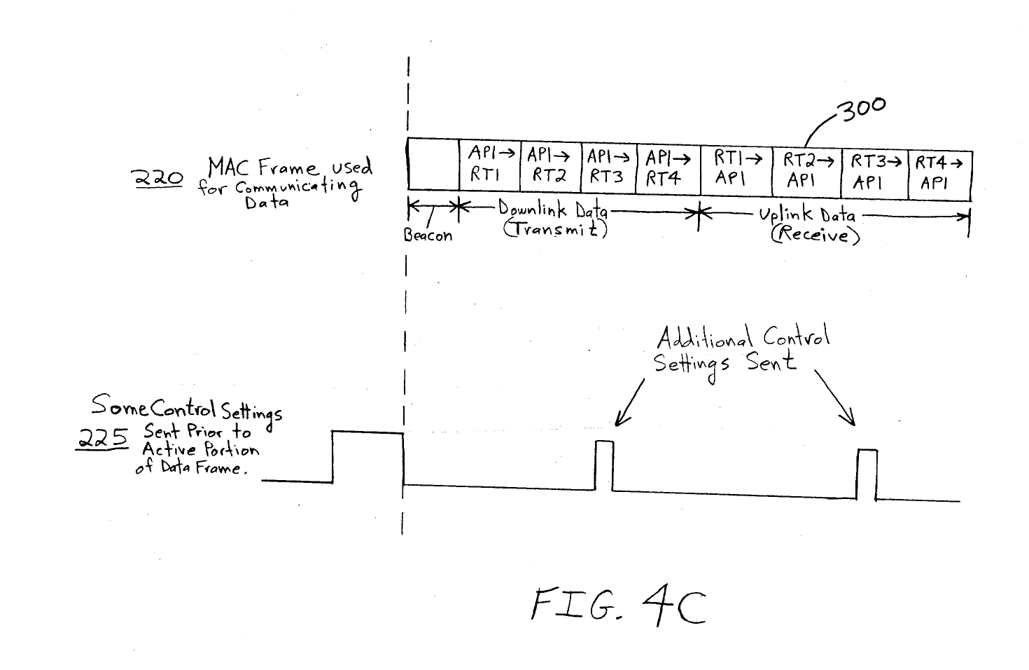

FIG. 6 illustrates one example bit stream assignment for the RX1, RX2, TX1 and PLL control words. Many variations of this bit stream assignment may be used in accordance with the present invention, and as mentioned above, the present invention is not limited to use in systems that use diversity reception or that include two receivers. The present invention may be used in systems having any number of receivers.

As illustrated, bit 42 is the most significant bit (MSB) and is sent across the serial bus 200 first. In this example four more control words are reserved for future expansion and for testing purposes when the A2 bit is set to “1”. Thus, this example bit stream assignment includes the ability to add more control words at a later time. Each control word is 43 bits long; however, the reserved bits may not be required. For example, the BBIC 102 may send a TX control word of length 38 bits instead of 43 bits.

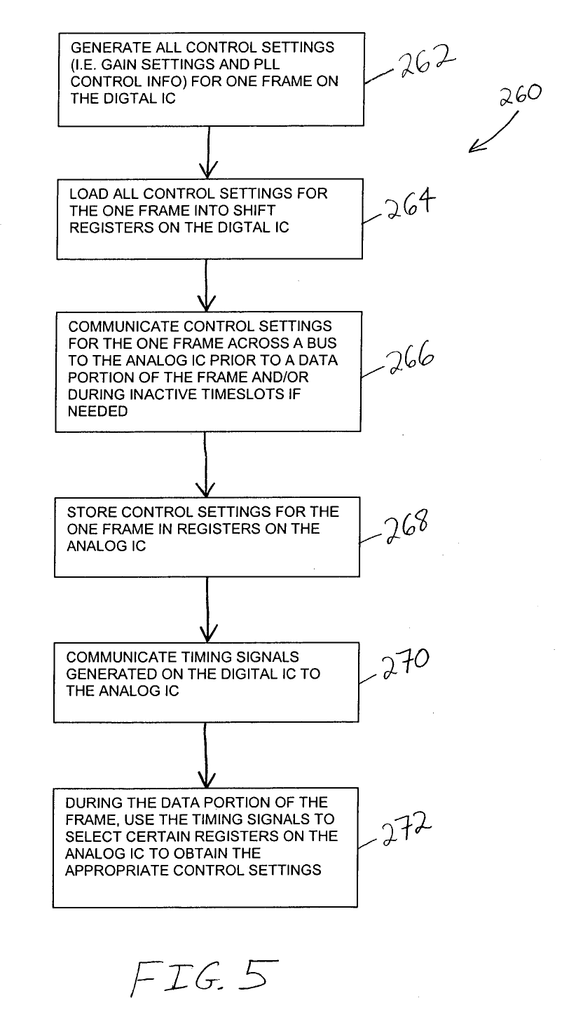

FIG. 7 provides a description of the bits in the RX1 and RX2 control words in the example bit stream assignment. The address bits are set to 000 for RX1 and to 001 for RX2. The 40 MSBs of the RX control word are transferred into either the RX1 (addr=000) or RX2 (addr=001) register bank 180, 182, respectively, upon the rising edge of LE in the 3-wire bus in this example. Alternatively, information could be latched on the falling edge of LE or triggered on a voltage level rather than an edge. Each of the register banks 180, 182 includes four 10-bit registers that are used for the AGC gain settings.

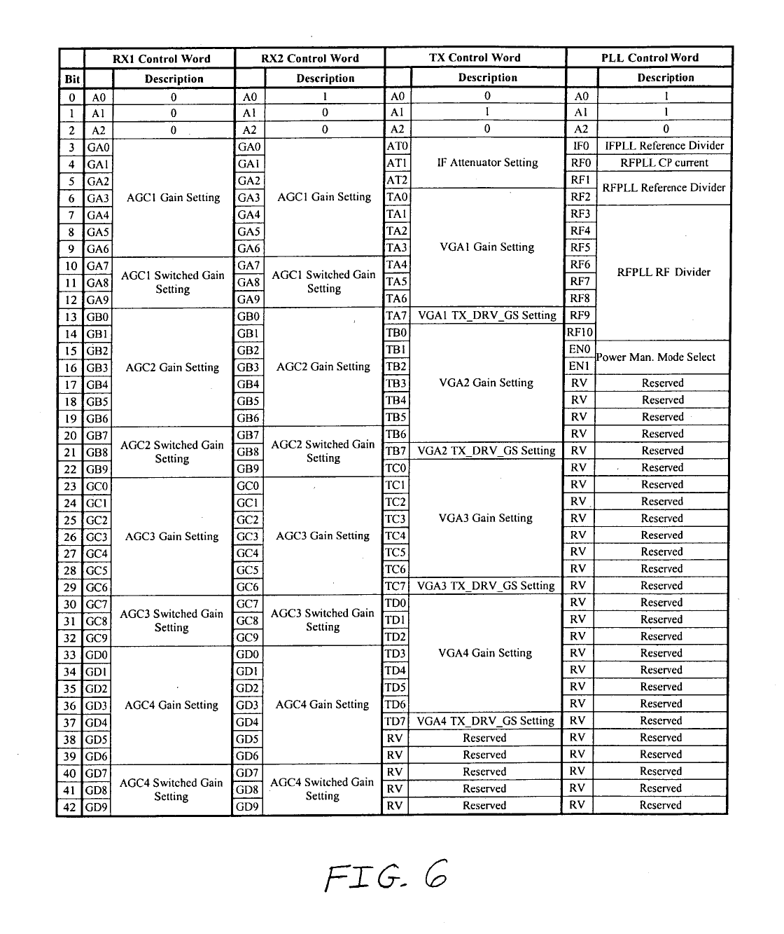

Each of the four RX AGC registers in this example are preferably identical and comprise 10 bits, which are allocated as shown in FIG. 8. Bits 0 through 6 allow selection of a 60 MHz AGC amplifier gain in the receiver amplifiers 160, 162, where a value of 0000000 commands maximum gain and a value of 1111111 commands minimum gain for this amplifier. Bits 7 through 9 are used to control two gain switches in the RFIC 106 and two gain switches in the IFIC 104. These three control bits can select eight different modes, but only five modes are used in normal operation in this example. The IFIC 104 decodes these three control bits as shown in FIG. 7, and then passes two control lines (RXn_LNA1_GS and RXn_LNA2_GS) for each RX channel from the IFIC 104 to the RFIC 106. Another two internal control signals are generated to set the gains of a 940 MHz LNA1 and LNA2 for each RX channel in the IFIC 104. A high state of these signals represents high gain of the corresponding amplifier and a low state of these signals represents low gain of the corresponding amplifier.

An example logical implementation of the serial 3-wire bus data flow for the RX1 control word is shown in FIG. 9. The implementation for the RX2 control word is substantially identical. The shift register shifts in (to the right) one bit of S_DATA on every rising edge of the S_CLK pin. After all of the 43 bits of S_DATA have been shifted in, they are latched to the appropriate registers upon the rising edge of the LE pin. Each of the output buffers of these registers stays at high impedance state until its enable signal goes high (“H”). Only one of the four registers (whose outputs are tied together) can be enabled at any given time. The enable signals are derived from T/R_SEL and the four AGC_CTLXs.

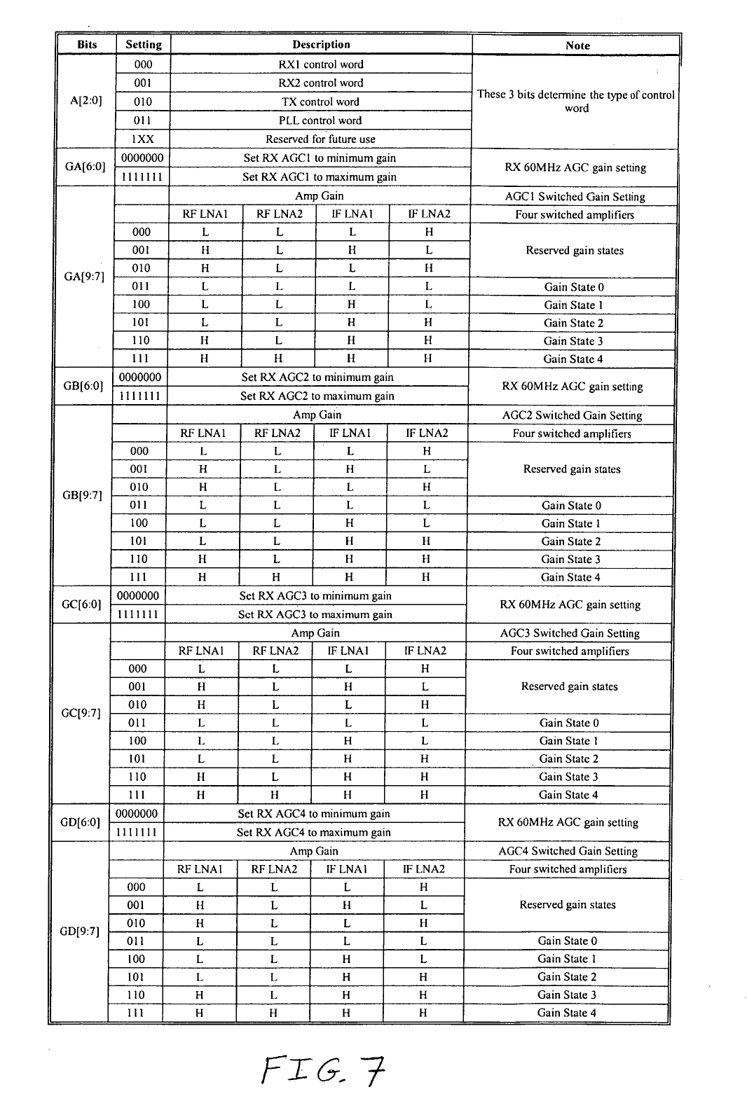

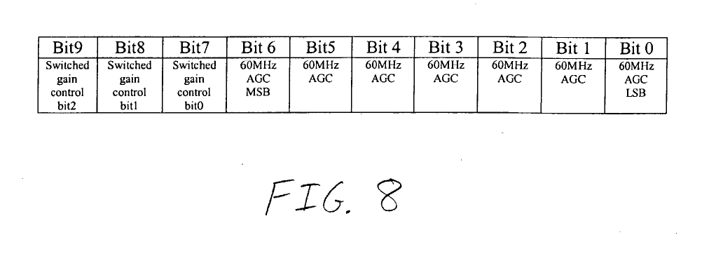

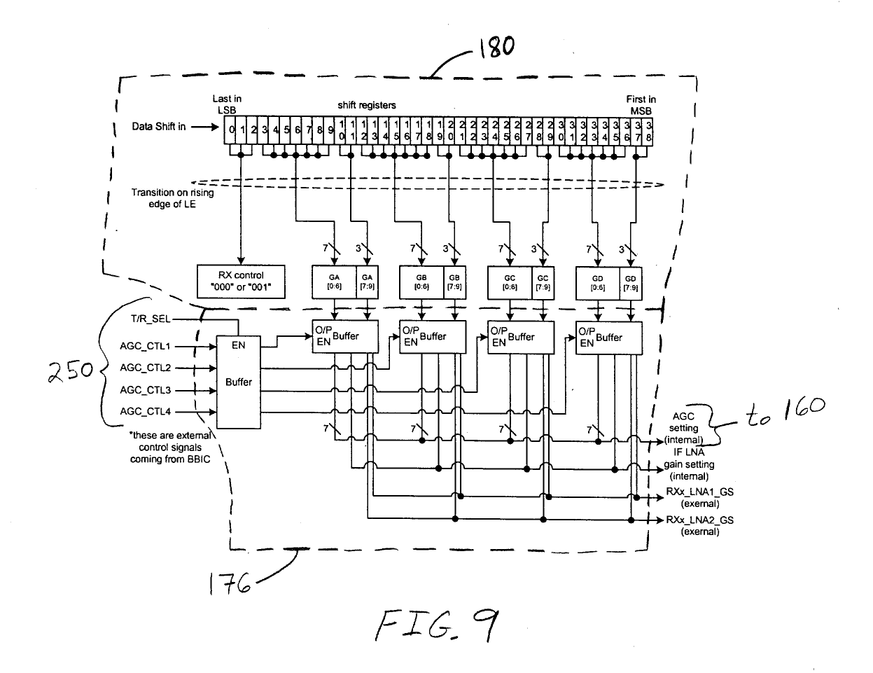

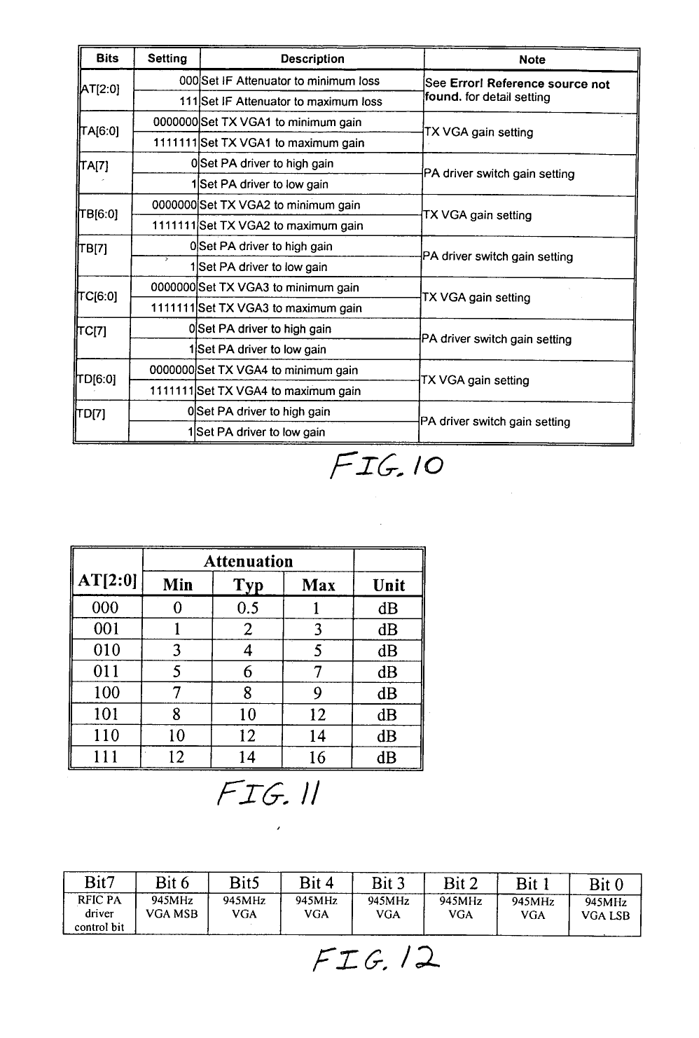

FIG. 10 provides a description of the bits in the TX1 control word in the example bit stream assignment. The address bits are set to 010 for TX. Three bits, AT[2:0], are used for setting up a TX attenuator, and the remaining bits are used for the PLC gain control words as previously discussed. In the tables, the PLC gain control words are indicated as Variable Gain Amplifier (VGA) gain settings. FIG. 11 shows an example relationship between the AT[2:0] bit pattern and attenuation for a 60 MHz TX attenuator.

The 32 MSBs of the TX1 control word are transferred into the TX1 register bank 198, which includes four 8-bit registers that are used for the VGA gain setting, upon the rising edge of the LE. The 33^{rd}, 34^{th} and 35^{th} MSBs are transferred to a 3-bit register, which sets the gain of the 60 MHz TX attenuator.

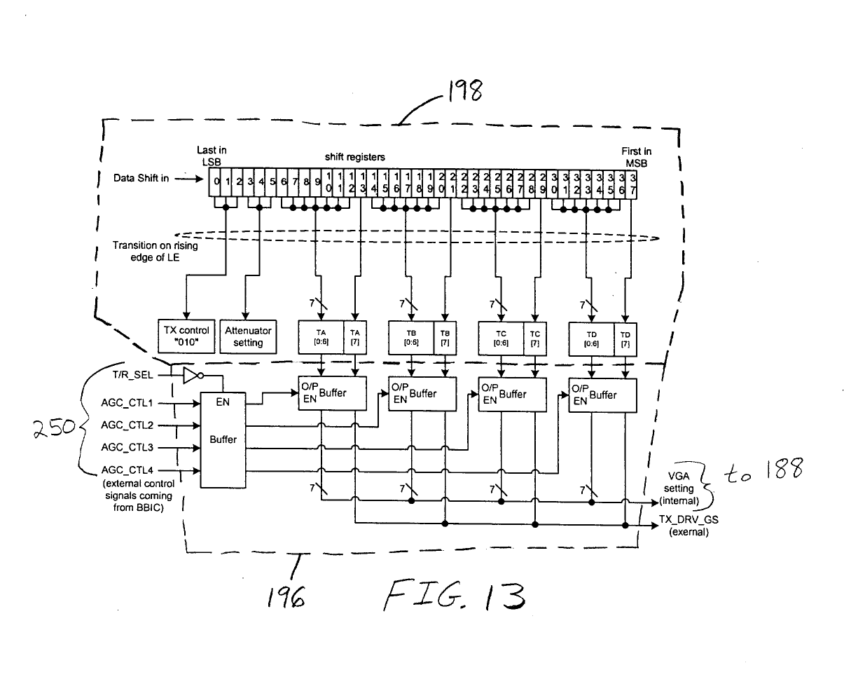

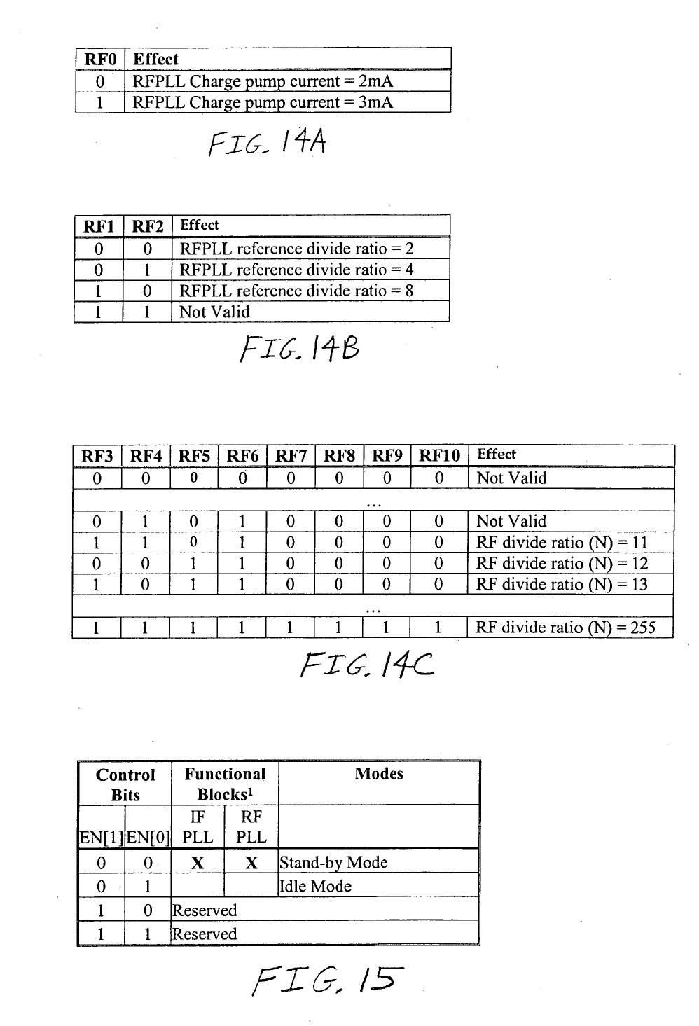

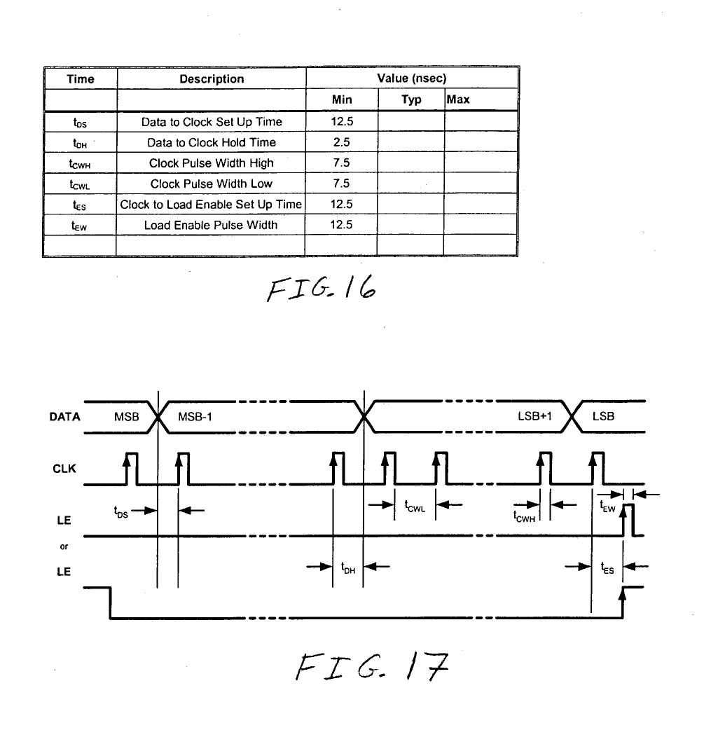

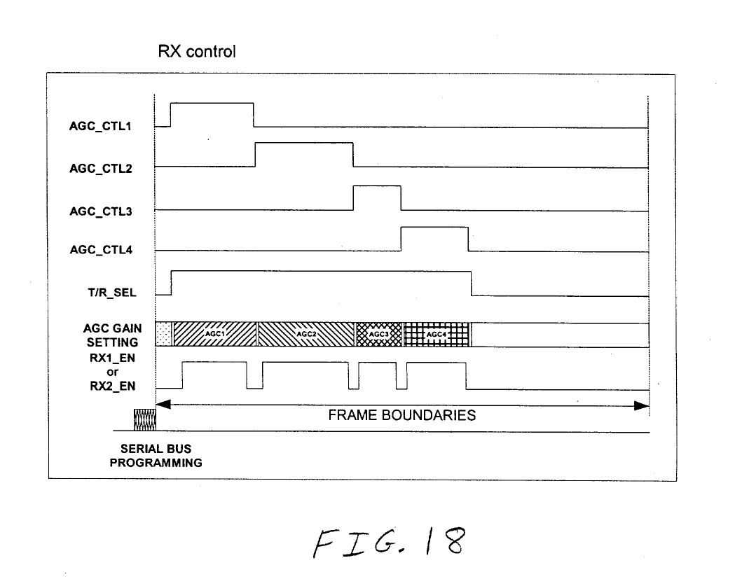

Each of the TX1 VGA registers in this example is preferably identical, and comprises 8 bits which are allocated as shown in FIG. 12. Bits 0 through 6 allow selection of the 940 MHz VGA amplifier gain in the TX1 transmitter amplifier 188, where a value of 0000000 commands minimum gain and a value of 1111111 commands maximum gain for this amplifier. Bit 7 is used to control a 5 GHz TX driver that is situated on the RFIC 106. To achieve this, a control line (TX_DRV_GS) is passed from the IFIC 104 to the RFIC 106. A bit 7 value of 0 shall correspond to a low state for this control line, while a bit 7 value of 1 shall correspond to a high state for this control line.

An example logical implementation of the serial 3-wire bus data flow for the TX1 control word is shown in FIG. 13. The shift register shifts in (to the right) one bit of S_DATA on every rising edge of the S_CLK pin. After all of the 38 bits of S_DATA have been shifted in, they are latched to the appropriate registers upon the rising edge of the LE pin. Each of the output buffers of these registers stays at high impedance state until its enable signal goes high (“H”). Only one of the four registers (whose outputs are tied together) can be enabled at any given time. The enable signals are derived from T/R_SEL and the four AGC_CTLXs.

A description of the bits in the PLL control word in the example bit stream assignment will now be provided. The address bits are set to 011 for the PLL control word. This control word is used to control the IF PLL 238, the RF PLL 240, and the power management mode selection block 242. Bit IF0 is used to control the IF PLL 238. Bits RF[10:0] are used to control the RF PLL 240. Bits EN[1:0] are used to select one of the power management modes.

With respect to the IF PLL 238, the IF local oscillator (LO) in his example is designed to oscillate at a fixed frequency of 2000 MHz. The IF0 bit is required to allow selection of a reference divide ratio. When IF0=low, then the reference divider is set to divide-by-1 and the phase detector comparison frequency is 20 MHz. When IF0=high, then the reference divider is set to divide-by-2 and the phase detector comparison frequency is 10 MHz.

With respect to the RF PLL 240, the range of the RF voltage controlled oscillator (VCO) is from 2105 MHz to 2205 MHz. The relationships between RF frequency and RF VCO frequency are given by the following equation:

RF frequency (MHz)=940+2*RF VCO (MHz)

The reference divide ratio is selectable and may be either 2, 4 or 8. The phase detector comparison frequency therefore is selectable between 2.5 MHz, 5 MHz or 10 MHz. The PLL has a variable RF divide ratio of between 11 and 82. The following equation is used to find N (the RF divide ratio):

N=0.025×(FRF−4940)×R (MHz)

where FRF is the RF Channel Frequency (in MHz), R is the reference divide ratio (equal to 2, 4 or 8), and N is the RF divide ratio. An example bit mapping of the RF PLL control word is shown in FIGS. 14A, 14B and 14C.

With respect to the power management mode selection block 242, two enable bits EN[1:0] in the PLL control word are used to select one of the power management modes as shown in FIG. 15. The two power management modes that are available in this example are a stand-by mode and an idle mode. In the stand-by mode the IF PLL 238 and the RF PLL 240 remain on, whereas they do not in the idle mode. The digital and transceiver sections are always on.

In this example implementation the serial 3-wire bus supports up to a 40 MHz clock rate. An example timing requirement is shown in FIG. 16, and an example timing diagram is shown in FIG. 17.

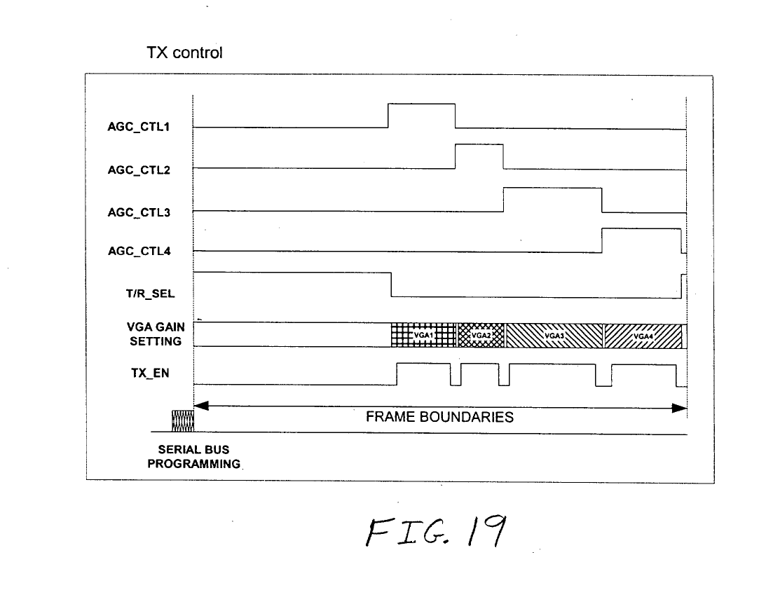

As discussed above, AGC_CTL1, AGC_CTL2, AGC_CTL3, and AGC_CTL4 select the appropriate register (one of four) to be activated, while T/R_SEL multiplexes these four signals to either the TX1 or RX1/2 gain control register banks as appropriate. For the RX portion of the frame, T/R_SEL is high and an example timing is shown in FIG. 18.

The following is an example of the control scheme. As shown above, when the T/R_SEL is high, then during the time that AGC_CTL1 is high the RX1_AGC1 and RX2_AGC1 portions of the AGC registers 180, 182, respectively, are active. This means that the RX1 and RX2 60 MHz AGC amplifier gains in RF amplifiers 160, 162 are set according to the contents of the 7 LSBs of the RX1_AGC1 and RX2_AGC1 registers. Furthermore, the RX1 940 MHz Switched LNA1 and LNA2 gains are set according to the contents of the 3 MSBs of the RX1_AGC1 registers, and the RX2 940 MHz Switched LNA1 and LNA2 gains are set according to the contents of the 3 MSBs of the RX2_AGC1 registers. The states of the RX1_LNA1 and RX1_LNA2 in the RFIC 106 are set according to the contents of the 3 MSBs of the RX1_AGC1 registers, and the states of the RX2_LNA1 and RX2_LNA2 in the RFIC 106 are set according to the contents of the 3 MSBs of the RX2_AGC1 registers. When AGC_CTL1 goes low and AGC_CTL2 goes high, this process is repeated for the RX1_AGC2 and RX2_AGC2 registers, etc.

For the TX1 portion of the frame, T/R_SEL is low and an example timing is as shown in FIG. 19. As shown above, when the T/R_SEL is low then during the time that AGC_CTL1 is high the VGA register TX_VGA1 is active. This means that the TX 940 MHz VGA amplifier gain is set according to the contents of the 7 LSBs of the TX_VGA1 register, and that the TX_RFGAIN RFIC gain control output is set according to the contents of the MSB of the TX₁₃ VGA1 register. When AGC_CTL1 goes low and AGC_CTL2 goes high, this process is repeated for the TX_VGA register, etc.

Referring to FIG. 20, there is illustrated an example RX received signal strength indicator (RSSI) sampling scheme that may be used to determine the required independent gain settings. Namely, as discussed above multiple gain control words, one for each timeslot, are programmed all together at the beginning of the frame. The determination of these control word settings may be accomplished by RSSI measurement. This is done by sampling of the ADC 158 (FIGS. 3B and 3C) output by the received power sensing blocks 154, 156. The RSSI measurement, which is a measurement of the absolute power reaching the RSSI sensing circuits 161, 163 in the receiver, is then processed by the gain computation algorithm blocks 164, 166, respectively. These blocks apply a computation which has as an input the RSSI measurement and as an output a receiver gain word which, when applied to set the receiver gain, acts to set the received power at the output of the receiver to a desired fixed level that results in optimal reception/demodulation. It is noted that the outputs 165, 167 of the RSSI sensing circuits 161, 163, as well as the output 169 of the TX power sensing block 186, are coupled to the ADC 158 via a multiplexer 171.

The multiple gain settings are calculated by measuring the RSSI in each of the timeslots. Using the timing signals 250, the measurement result is applied to the registers associated with the appropriate timeslot. For example, the RSSI SAMPLE1 signal is used to trigger an RSSI measurement by the received power sensing blocks 154, 156, followed by operation of the gain computation algorithm blocks 164, 166 and entry of the resulting word in the gain word registers 172, 174 associated with timeslot 1. The resulting gain word is then applied in timeslot 1 of the subsequent frame. The same process for timeslots 2, 3 and 4 is achieved by application of the RSSI SAMPLE2, RSSI SAMPLE3 and RSSI SAMPLE4 signals, respectively.

The RSSI sensing circuits 161, 163 in the analog IC 152 compute the rms signal voltage in real-time. But for the bandlimiting nature of the IF filters, the voltage variations would be extremely fast with time. And as mentioned above, the peak-to-average-power-ratio (PAR) for OFDM is quite high. In order to prevent the generation of misleading data by these random peaks, the outputs of the ARSSI detectors 161, 163 may be time-averaged by using an RC filter 157 just prior to the ADC 158 in the digital IC 150. The capacitor C is preferably external to the ICs 150, 152.

The time constant for the RC filter 157 should preferably be long compared to an OFDM symbol in order to average out as much of the PAR as possible. On the other hand, if the time constant is more than a fraction of an OFDM symbol, it inhibits the ability to rapidly measure the power levels on time-adjacent post-amble symbols. A reasonable compromise is to use a time constant of 0.5 to 1.0 usec.

Use of the smoothing filter 157 also alleviates frequency response issues that would otherwise be imposed on the auxiliary ADC that measures the analog voltage. Furthermore, due to the high PAR of OFDM, it is preferable to make power measurements, whether TX or RX related, during signal intervals where the PAR is at a minimum, such as during preambles or post-ambles. There are multiple such preambles and post-ambles possible during a MAC frame. Therefore, the auxiliary ADC is preferably flexible so that it can measure signal power at different points during any given MAC frame.

Referring again to FIG. 4B, with respect to the use of the antenna pair switching information, antennas should preferably be precisely selected with a time precision better than about 50 nsec so that the correct antenna pair is being “listened to” at the right times. With respect to making ARSSI measurements with the auxiliary ADC, samples should preferably be taken with a precision 1 usec spacing and the start of the sampling should preferably be controlled to the same precision. These switching and measurement events can occur multiple times per MAC frame over a wide range of relative time locations. That is, the post-amble symbols shown in FIG. 4B may be appended/inserted in a range of different message types within a typical MAC frame. The signal power is of course also measured in the standard received preamble region.

While the invention herein disclosed has been described by means of specific embodiments and applications thereof, numerous modifications and variations could be made thereto by those skilled in the art without departing from the scope of the invention set forth in the claims.

What is claimed is:

1. A method of handling control information in a first integrated circuit (IC) used for wireless communications, comprising the steps of:
receiving in the first IC a plurality of control settings that were generated in a second IC and communicated across a bus from the second IC to the first IC prior to a data portion of a frame used by the first and second ICs in communicating data; and
receiving in the first IC one or more timing signals that are generated in the second IC and that are for use during the data portion of the frame for selecting certain ones of a plurality of registers in the first IC that are used for storing the plurality of control settings.

2. A method in accordance with claim 1, wherein the plurality of control settings comprises a plurality of gain settings.

3. A method in accordance with claim 1, wherein the plurality of control settings comprises a plurality of gain settings for a first receiver amplifier and a plurality of gain settings for a transmitter amplifier.

4. A method in accordance with claim 3, wherein each of the gain settings for the first receiver amplifier is for use with a different communication link, and each of the gain settings for the transmitter amplifier is for use with a different communication link.

5. A method in accordance with claim 3, wherein the plurality of gain settings for the first receiver amplifier are grouped into a first control word, and the plurality of gain settings for the transmitter amplifier are grouped into a second control word.

6. A method in accordance with claim 1, wherein the plurality of control settings comprises a plurality of gain settings for a first receiver amplifier, a plurality of gain settings for a second receiver amplifier, and a plurality of gain settings for a transmitter amplifier.

7. A method in accordance with claim 1, wherein the plurality of control settings comprises phase lock loop (PLL) control information.

8. A method in accordance with claim 7, wherein the PLL control information is grouped into a control word that is separate from a plurality of gain settings that are also included in the plurality of control settings.

9. A method in accordance with claim 1, wherein the plurality of control settings comprises power management mode information.

10. A method in accordance with claim 1, wherein each of the one or more timing signals generated in the second IC corresponds to a different communication link.

11. A method in accordance with claim 1, wherein the bus comprises a serial bus.

12. A method in accordance with claim 1, wherein the first IC comprises intermediate frequency (IF) circuitry and the second IC comprises baseband circuitry.

13. A method in accordance with claim 12, wherein the first IC further comprises radio frequency (RF) circuitry.

14. A method in accordance with claim 1, further comprising the steps of:
storing the plurality of control settings in a plurality of registers in the first IC;
selecting one of the plurality of registers in response to the one or more timing signals; and
loading a gain setting from the selected register into an amplifier for communication with a communication link to which the gain setting corresponds.

15. A method of handling control information in a first integrated circuit (IC) used for wireless communications, comprising the steps of:
receiving in the first IC a first control word and a second control word that were assembled in a second IC and communicated across a bus from the second IC to the first IC prior to a data portion of a frame used by the first and second ICs in communicating data, wherein the first control word includes a plurality of first receive gain settings for a first receiver amplifier, and the second control word includes a plurality of transmit gain settings for a transmitter amplifier; and
receiving in the first IC one or more timing signals that are generated in the second IC and that are used during the data portion of the frame for selecting certain ones of a plurality of registers in the first IC that are used for storing the plurality of first receive gain settings and the plurality of transmit gain settings.

16. A method in accordance with claim 15, wherein each of the first receive gain settings is for use with a different communication link, and each of the transmit gain settings is for use with a different communication link.

17. A method in accordance with claim 15, further comprising the step of:
receiving in the first IC a third control word that was assembled in the second IC and communicated across the bus from the second IC to the first IC along with the first and second control words prior to the data portion of the frame, wherein the third control word includes a plurality of second receive gain settings for a second receiver amplifier.

18. A method in accordance with claim 15, further comprising the step of:
receiving in the first IC a third control word that was assembled in the second IC and communicated across the bus from the second IC to the first IC along with the first and second control words prior to the data portion of the frame, wherein the third control word includes phase lock loop (PLL) control information.

19. A method in accordance with claim 15, further comprising the step of:
receiving in the first IC a third control word that was assembled in the second IC and communicated across the bus from the second IC to the first IC along with the first and second control words prior to the data portion of the frame, wherein the third control word includes power management mode information.

20. A method in accordance with claim 15, further comprising the steps of:
storing the plurality of first receive gain settings in a plurality of first receive registers and the plurality of transmit gain settings in a plurality of transmit registers in the first IC;
selecting one of the plurality of first receive registers during an uplink portion of the frame in response to the one or more timing signals; and
loading a gain setting from the selected register into the first receiver amplifier for communication with a communication link to which the gain setting corresponds.

21. A method in accordance with claim 15, wherein the first control word and the second control word are received in the first IC in a serial manner.

22. A method in accordance with claim 15, wherein the first IC comprises intermediate frequency (IF) circuitry and the second IC comprises baseband circuitry.

23. A first integrated circuit (IC) for use in wireless communications, comprising:
a serial interface configured to receive a plurality of control settings communicated from a second IC prior to a data portion of a frame used by the first and second ICs in wirelessly communicating data, wherein the plurality of control settings are for use by the first IC during the data portion of the frame; and
one or more inputs configured to receive one or more timing signals from the second IC that are for use by the first IC during the data portion of the frame for selecting certain ones of a plurality of registers in the first IC that are used for storing the plurality of control settings.

24. A first IC in accordance with claim 23, wherein the plurality of control settings comprises a plurality of first receive gain settings for a first receiver amplifier and a plurality of transmit gain settings for a transmitter amplifier.

25. A first IC in accordance with claim 24, wherein each of the first receive gain settings is for use with a different communication link, and each of the transmit gain settings is for use with a different communication link.

26. A first IC in accordance with claim 24, wherein the plurality of control settings further comprises a plurality of second receive gain settings for a second receiver amplifier.

27. A first IC in accordance with claim 24, wherein the plurality of control settings further comprises phase lock loop (PLL) control information that is grouped into a control word that is separate from the plurality of first receive gain settings and the plurality of transmit gain settings.

28. A first IC in accordance with claim 24, wherein the plurality of control settings further comprises power management mode information.

29. A first IC in accordance with claim 23, further comprising intermediate frequency (IF) circuitry.

30. A first IC in accordance with claim 29, further comprising radio frequency (RF) circuitry.

31. A first integrated circuit (IC) for use in wireless communications, comprising:
a serial interface configured to receive a plurality of first receive gain settings for a first receiver amplifier and a plurality of transmit gain settings for a transmitter amplifier communicated from a second IC prior to a data portion of a frame used by the first and second ICs in wirelessly communicating data;
a plurality of first receive registers configured to store the plurality of first receive gain settings;
a plurality of transmit registers configured to store the plurality of transmit gain settings;
one or more inputs configured to receive one or more timing signals from the second IC; and
means for selecting certain ones of the plurality of first receive registers and the plurality of transmit registers during the data portion of the frame in response to the one or more timing signals.

32. A first IC in accordance with claim 31, further comprising:
means for loading a first receive gain setting from a selected first receive register into the first receiver amplifier during an uplink portion of the frame to receive data from a communication link to which the receive gain setting corresponds.

33. A first IC in accordance with claim 31, further comprising:
means for loading a transmit gain setting from a selected transmit register into the transmitter amplifier during a downlink portion of the frame to transmit data along a communication link to which the transmit gain setting corresponds.

34. A method in accordance with claim 1, further comprising the step of:
receiving in the first IC one or more additional control settings that were generated in the second IC and communicated across the bus from the second IC to the first IC during a non-active time slot within the frame.

35. A method in accordance with claim 15, further comprising the step of:
receiving in the first IC an additional control word that was assembled in the second IC and communicated across the bus from the second IC to the first IC during a non-active time slot within the frame.

36. A first IC in accordance with claim 23, wherein the serial interface is further configured to receive one or more additional control settings communicated from the second IC during a non-active time slot within the frame.
